(19) United States
(12) Patent Application Publication
(10) Pub. No.: US 2005/0088261 A1
(43) Pub. Date: Apr. 28, 2005

(54) Method of making a micromechanical device

(76) Inventors: Lianjun Liu, Gilbert, AZ (US); Steven M. Smith, Gilbert, AZ (US)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 10/692,548

(22) Filed: Oct. 24, 2003

(51) Int. Cl. H01H 51/22

(52) U.S. Cl. 333/262

(57) ABSTRACT

A method of making a micromechanical device including forming a dielectric layer over a sacrificial layer, wherein the dielectric layer includes silicon, oxygen and nitrogen. In on embodiment, the dielectric layer is silicon oxynitride formed using plasma enhanced chemical vapor deposition (PECVD). Silicon oxynitride can easily be formed as a low stress material, unlike silicon dioxide, and does not have a large charge trap density like silicon nitride.

### BACKGROUND OF THE INVENTION

This invention relates, in general, to semiconductor devices, and more particularly, to a method of fabricating micromechanical devices.

Micromechanical devices are used for a wide range of applications. These devices or micro-switches have the advantage of providing superior switching characteristics over a wide range of frequencies. One type of micromechanical switch structure utilizes a cantilever beam design. A cantilever beam with contact metal thereon rests above an input signal line and an output signal line. During switch operation, the beam is electrostatically actuated by applying voltage to an electrode below the cantilever beam. Electrostatic force pulls the cantilever beam toward the input signal line and the output signal line, thus creating a conduction path between the input line and the output line through the metal contact on the cantilever beam.

In fabricating this type of micro-switch, manufacturing nonuniformity can result in poor metal step coverage of the contact metal. Poor metal step coverage results in micromechanical devices having decreased reliability and performance. If the step coverage is poor enough, voids in the contact metal can cause problems with the formation of the conduction path described above.

In view of the foregoing discussion, it would be advantageous to have a more manufacturable process for making electromechanical devices. Accordingly, there is a need for a micromechanical device with reliable mechanical and electrical contact characteristics.

### BRIEF DESCRIPTION OF THE DRAWINGS

FIG. 1 illustrates a cross-sectional view of a device in a beginning stage of fabrication according to an embodiment of the present invention;

FIG. 2 illustrates a cross-sectional view of the device of FIG. 1 further along in processing;

FIG. 3 illustrates a cross-sectional view taken along line 3-3 of the device shown in FIG. 2;

FIG. 4 illustrates a cross-sectional view of the device of FIG. 2 further along in processing;

FIG. 5 illustrates a cross-sectional view of the device of FIG. 4 further along in processing;

FIG. 6 illustrates a cross-sectional view of the device of FIG. 5 further along in processing;

FIG. 7 illustrates a cross-sectional view taken along line 7-7 of the device shown in FIG. 6;

FIG. 8 illustrates a cross-sectional view of the device of FIG. 6 further along in processing;

FIG. 9 illustrates a cross-sectional view of the device of FIG. 8 further along in processing;

FIG. 10 illustrates a cross-sectional view of the device of FIG. 9 further along in processing;

FIG. 11 illustrates a perspective view taken along line 11-11 of a portion of the device of FIG. 10 further along in processing; and

FIG. 12 illustrates process parameters for forming a dielectric layer including silicon oxynitride in accordance with an embodiment of the present invention.

### DETAILED DESCRIPTION OF THE PREFERRED EMBODIMENTS

The present invention relates to structures and methods for forming a micromechanical device. More particularly, the present invention utilizes a two step process for forming a recess in which a metal contact of a cantilever beam is formed. The two step process results in, among other things, the formation of a metal contact having better step coverage and a smoother surface, which results in a micromechanical device having better reliability and electrical characteristics.

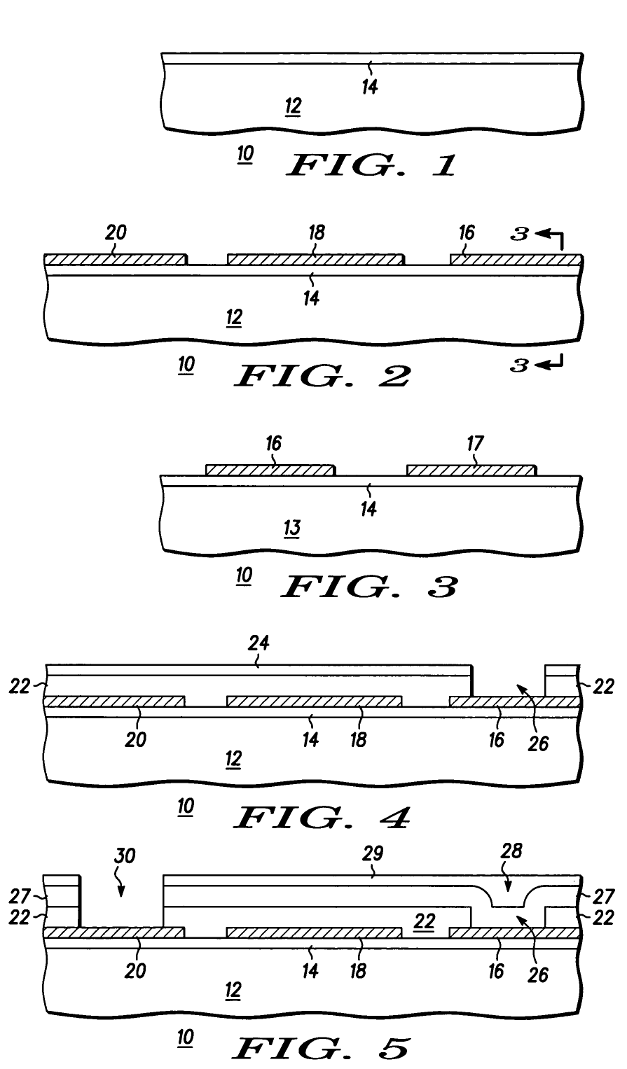

Turning now to the figures, FIG. 1 illustrates a cross-sectional view of a device 10 in a beginning stage of fabrication according to an embodiment of the present invention. First, a substrate 12 is provided which provides for structural or mechanical support. Preferably, substrate 12 is comprised of material that does not allow any Radio Frequency (RF) losses. Preferably, materials such as a high resistivity silicon, gallium arsenide (GaAs), or glass may comprise substrate 12 because these materials are compatible with semiconductor processes. Other materials may be suitable. High resistivity silicon having a resistivity from 100 Ω-cm to 10,000 Ω-cm is suitable.

Next, an isolation layer 14 is formed over substrate 12. Isolation layer 14 is preferably comprised of silicon dioxide, although other nonconductive materials may be used. Further, the optimum choice of this material is dependent on what comprises substrate 12. If silicon dioxide is used, a thickness of approximately 0.5 to 5 microns is suitable and may be formed by either thermal oxidation techniques or deposition, which are both well known in the semiconductor processing art. The formation of isolation layer 14 provides for further isolation between substrate 12 and conductive layers formed as described below.

With reference to FIGS. 2 and 3, FIG. 2 illustrates a cross-sectional view of device 10 further along in processing. FIG. 3 illustrates a cross-sectional view of device 10 taken along line 3-3 at the same processing stage as FIG. 2. Input signal line 16, output signal line 17, ground contact 18, and top contact 20 are formed over isolation layer 14. Preferably, input signal line 16, output signal line 17, ground contact 18, and top contact 20 are formed of the same material(s) and at the same time. These contact layers or electrodes can be formed by lift off techniques or by first forming and then patterning a metal layer or metal layers over isolation layer 14. A lift-off process is preferred if metal materials used are difficult to pattern using etching techniques. Either method of forming these contact layers is well known in the art. Input signal line 16 is physically separated from output signal line 17.

Input signal line 16, output signal line 17, ground contact 18, and top contact 20 are preferably comprised of a conductive layer which is a non-oxidizing metal or metal layers, such as, for example, chrome and gold (with chrome being deposited first). If chrome and gold are used, a suitable thickness of chrome is 100-300 angstroms and of gold is 0.5-3 microns.

FIG. 4 illustrates device 10 further along in processing. A first sacrificial layer 22 is formed over isolation layer 14 and input signal line 16, output signal line 17, and ground contact 18. First sacrificial layer 22 is preferably comprised of polyimide. The thickness of first sacrificial layer 22 is preferably in the range of 0.5-2 microns, but should be at least the height of a recess step to be described hereinafter.

First sacrificial layer 22 is coated on the surface of device 10 and then heated. Preferably, first sacrificial layer 22 is partially cured in order to reduce processing time. Fully curing first sacrificial layer 22 is not required at this time, because further heat cycles will cure it. That a polyimide layer is fully cured means that the polyimide is fully imidized.

The following table shows a suitable partial cure process for first sacrificial layer 22.

| Process | Temperature (^{□}C.) | Time (min) |
|---|---|---|
| Ramp | 140-150 | 30 |
| Ramp and cure | 250 | 30 |
| Cool down | 140-150 | 30 |
| Cool down | room temperature - | |

It should be noted that other times and temperatures may provide desired results.

Subsequently, first and second openings 26 are formed in first sacrificial layer 22 over input signal line 16 (shown in FIG. 4) and output signal line 17 (not shown in FIG. 4, see FIG. 7). Openings 26 are formed by first providing a masking layer 24 over first sacrificial layer 22 and then patterning masking layer 24 to provide openings 26 in masking layer 24. Masking layer 24 can be comprised of a resist layer or a hardmask layer such as silicon dioxide (SiO₂). A portion of sacrificial layer 22 is then etched so that openings 26 extend down to input signal line 16 (shown in FIG. 4) and output signal line 17 (not shown in FIG. 4, see FIG. 7). An oxygen (O₂) plasma is preferably used to dry etch first sacrificial layer 22 to form openings 26 therein.

FIG. 5 illustrates device 10 of FIG. 4 where masking layer 24 has been removed and a second sacrificial layer 27 is formed over first sacrificial layer 22, including in openings 26 over input signal line 16 (and output signal line 17, shown in FIG. 7). Second sacrificial layer 27 is preferably comprised of polyimide. The thickness of second sacrificial layer 27 in this embodiment is in the range of 1-3 microns. Preferably, second sacrificial layer 27 should be at least thin enough so that first and second recesses 28 are formed covering openings 26 (second recess 28 is shown in FIG. 7).

Second sacrificial layer 27 is coated on the surface of device 10 and then heated. In this case it is desirable to fully cure second sacrificial layer 27 (which will fully cure first sacrificial layer 22 as well) at a temperature above 250 □C. For example, this cure process can be like the heating process of first sacrificial layer 22, except that the temperature is ramped to approximately 350 □C for a ramp and cure time of approximately 30 minutes.

This two step process of forming first sacrificial layer 22 and second sacrificial layer 27 allows for the formation of recesses 28 which do not have steep sidewalls. In addition, because an etch step is not performed to form recesses 28, the surface of second sacrificial layer 27 in the area of recesses 28 is smooth and the sidewalls have a rounded profile. Further, the depth or height of recesses 28 can be more readily controlled (by controlling the thickness of first sacrificial layer 22 and second sacrificial layer 27), than if a dry etch is performed in a single sacrificial layer where etching would have to terminate within the sacrificial layer.

Still with reference to FIG. 5, an opening or anchor recess 30 is formed in second sacrificial layer 27 and first sacrificial layer 22 over top contact 20. First, a masking layer 29 is formed over sacrificial layer 27 and then patterned to provide an opening 30. Opening 30 can be formed by using a photolithography and etch process which is well known in the semiconductor fabrication art. Masking layer 29 can be comprised of a resist layer or a hardmask layer such as SiO₂. Second sacrificial layer 27 and first sacrificial layer 22 are then preferably dry etched so that opening 30 extends to top contact 20. The method discussed above for forming opening 26 may be used here as well.

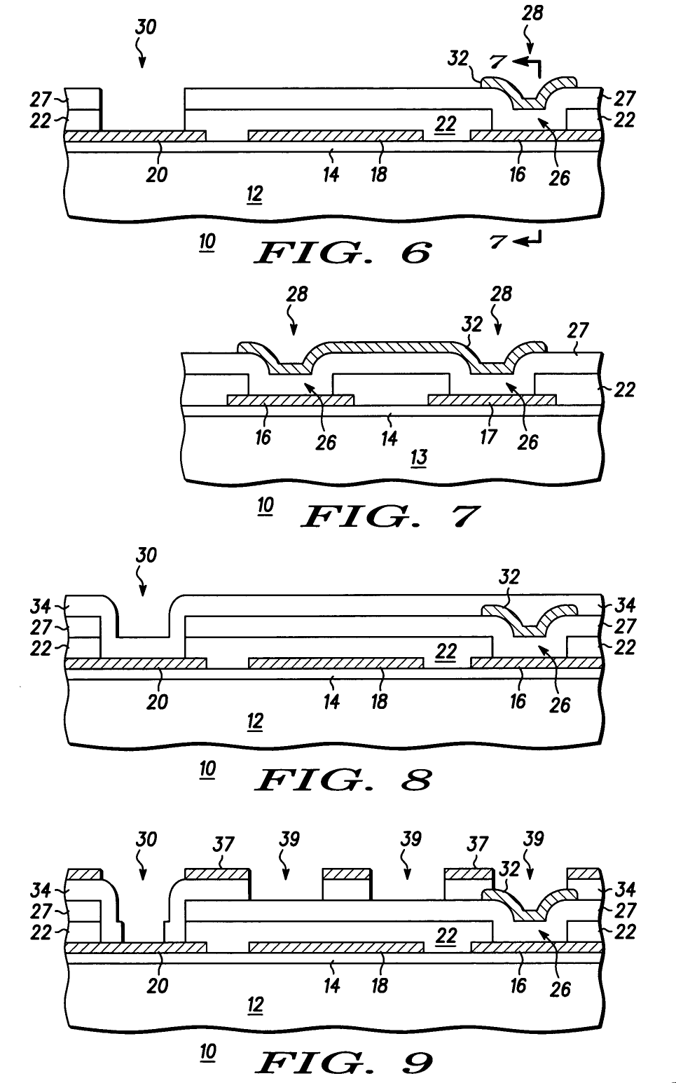

Now with reference to FIGS. 6 and 7, FIG. 6 illustrates device 10 of FIG. 5 further along in processing. FIG. 7 illustrates the structure of FIG. 6 taken along line 7-7. Masking layer 29 is removed. A contact or shorting bar 32 is formed over input signal line 16 and output signal line 17 over recesses 28 of second sacrificial layer 27. In FIG. 7, one can see that shorting bar 32 bridges over input signal line 16 and output signal line 17. Shorting bar 32 is preferably formed using lift-off techniques. Lift-off techniques are well known in the art and thus this step is not described further.

Shorting bar 32 should be comprised of a conductive layer or metal that is compatible with input signal line 16 and output signal line 17. In a preferred embodiment, shorting bar 32 is comprised of a layer of gold and a layer of chrome. Gold is formed first so that it is in contact with the gold of input signal line 16 and output signal line 17 when closed during switch operation. A suitable amount of gold is 4000-20,000 angstroms and a suitable amount of chrome is 150-250 angstroms, however, other thicknesses may be suitable.

FIG. 8 illustrates a cross-sectional view of device 10 further along in processing. A dielectric layer 34 is formed over second sacrificial layer 27, over shorting bar 32, and in opening 30. Dielectric layer 34 is preferably comprised of silicon dioxide, silicon oxynitride or silicon nitride, but other dielectrics may be used as well, including a composite layer of different dielectrics. The thickness of dielectric layer 34 is in the range of 1-3 microns and preferably formed by Plasma Enhanced Chemical Vapor Deposition (PECVD) to produce a low stress dielectric layer.

In a preferred embodiment, the dielectric layer 34 comprises silicon oxynitride. In other words, the dielectric layer 34 comprises silicon, nitrogen and oxygen. The silicon oxynitride may also comprise hydrogen that is inherently incorporated from the precursors used in the fabrication process, if the precursors include hydrogen. If different precursors than those taught herein are used, the silicon oxynitride may not include hydrogen. Although the dielectric layer 34 may comprise silicon dioxide, it is difficult to form a low stress silicon dioxide layer. If the dielectric layer 34 is stressed then the dielectric layer 34 will undesirably be unlevel. Silicon nitride, however, can be easily formed with low stress. However, silicon nitride has a high density of charge traps. Over time as a voltage is applied to the MEM structure electrons will be injected in to the silicon nitride and will be trapped. As the number of trapped charges increases, the voltage needed to open and close the MEM is undesirably increased. However, when using silicon oxynitride as the dielectric layer 34 the undesirable effects of silicon dioxide and silicon nitride are avoided.

Silicon oxynitride formed using PECVD is desirable for the dielectric layer 34 because it has a low stress (i.e., approximately 0 to approximately 4e8 dyne/cm ), it has good deposition uniformity (less than plus or minus approximately 5%, or more preferably, 3%), the film is stable after subsequent processing, and the film does not exhibit charge trapping phenomenon as occurs with silicon nitride. Furthermore, the actuation voltage for the MEM device is not significantly altered for many cycles of operation (e.g., more than 2e10 cycles). In addition, the material has good mechanical reliability and is easy to fabricate. Furthermore, because the PECVD process occurs at low temperatures the process is compatible with other materials and processes.

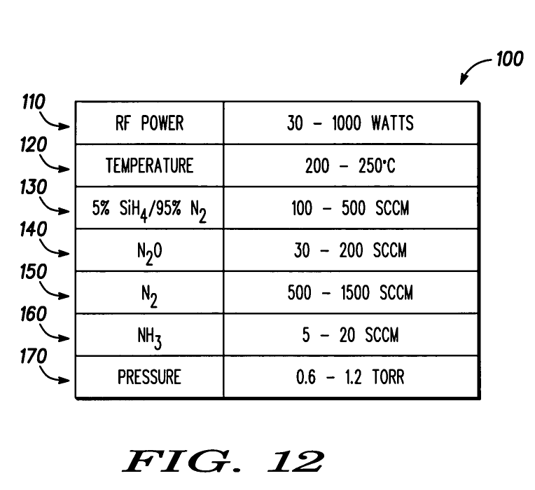

In one embodiment, the silicon oxynitride is formed using PECVD. Table 100 of FIG. 12 outlines ranges for parameters that can be used to form silicon oxynitride by PECVD in accordance with one embodiment. For example, row 110 illustrates that the RF Power may be approximately 30 to 100 Watts and row 120 illustrates that the temperature may be approximately 200 to 350 degrees Celsius. In one embodiment, SiH₄, N₂O, N₂ and NH₃ are the precursors used. As shown in FIG. 12, approximately 100-200 sccm of 5% SiH4/95% N₂ may be used (row 130), approximately 30-200 sccm of N₂O may be used (row 140), approximately 500 to 1500 sccm of N₂ may be used (row 150) and approximately 5-20 sccm of NH₃ may be used (row 160). Additionally, the pressure used as shown in row 170 may be approximately 0.6 to 1.2 Torr. In a preferred embodiment, the RF power is approximately 45 Watts, the temperature is approximately 240 degrees Celsius, the pressure is approximately 0.9 Torr, approximately 300 sccm of 5% SiH4/95% N₂ is used, approximately 90 sccm of N₂O is used, approximately 900 sccm of N₂ is used and approximately 10 sccm of NH₃ is used. A skilled artisan recognizes that these parameters are examples only and that the actual values may differ especially from tool to tool and factory to factory. In addition, other processes can be used to form the dielectric layer 34, such as physical vapor deposition (PVD).

Any silicon oxynitride may be used, thus the chemical formula may be written as SiOₓN_{y}. If it is desirable for the silicon oxynitride to have properties more like silicon dioxide, then the process can be modified by increasing the N₂O/NH₃ flow ratio. If instead, it is desirable to form a silicon oxynitride that is more like silicon nitride than silicon dioxide, then the amount of N₂O/NH₃ flow ratio can be decreased.

The voltages applied to the MEM structure may be modified when using silicon oxynitride as the dielectric layer 34. A skilled artisan recognizes that the voltage depends on many factors, such as the material used, thicknesses of material, geometries of materials, etc. If the air gap or polyimide thickness is approximately 3 microns, the silicon oxynitride thickness is approximately 2 microns and the cantilever geometries are defined as: approximately 80 microns in arm's length, approximately 12 microns in arm's width, the actuation voltage will be approximately 20 to 80 Volts, or more preferably between approximately 25-35 Volts.

FIG. 9 illustrates a cross-sectional view of device 10 further along in processing. A top electrode 37 is formed over dielectric layer 34. Top electrode 37 is preferably comprised of titanium and gold. For example, 150-250 angstroms of titanium and 1000-3000 angstroms of gold may be formed. Top electrode 37 having openings 39 formed therein is preferably formed by using photoresist lift-off techniques.

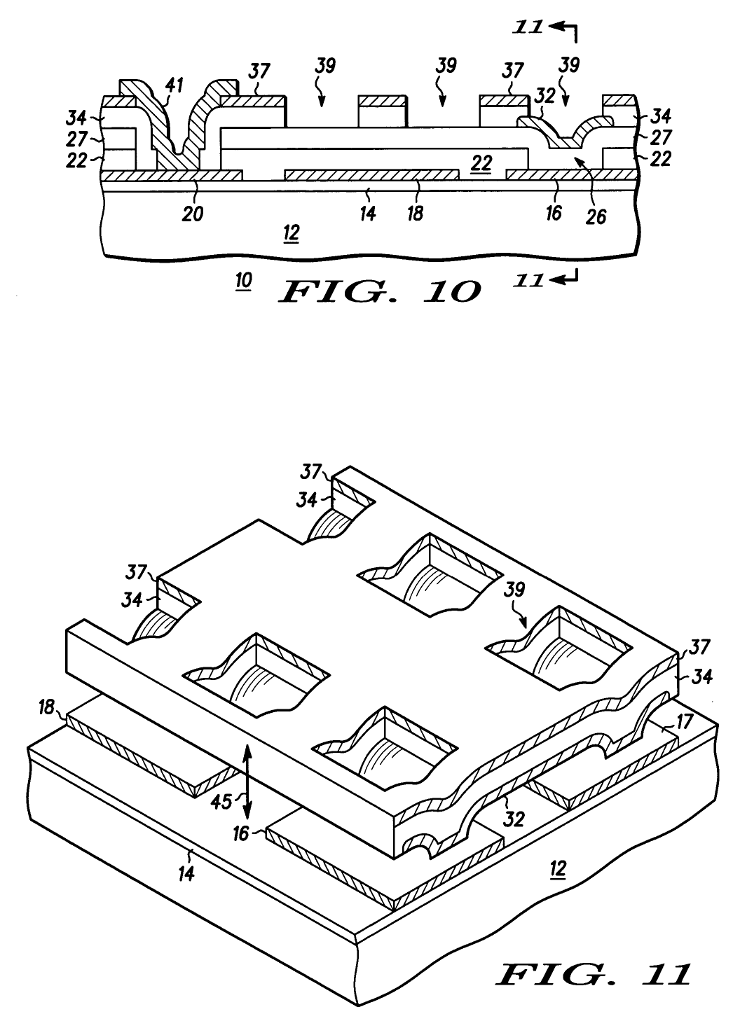

Subsequently, the cantilever structure is defined and openings 39 in dielectric layer 34 are formed using conventional photolithography and etch processes to remove portions of dielectric layer 34. Openings 39 in dielectric 34 are formed in order to enable the subsequent removal of first sacrificial layer 22 and second sacrificial layer 27 to release the cantilever structure comprised of dielectric layer 34, shorting bar 32, and top electrode 37 in a reasonable amount of time. The cantilever structure will be more readily seen with reference to FIG. 11. A portion of dielectric layer 34 is also removed over top contact 20 to have opening 30 extend to top contact 20.

FIG. 10 illustrates a cross-sectional view of device 10 further along in processing. A pad metal 41 is formed to electrically couple top contact 20 and top electrode 37. Pad metal 41 is preferably formed by using lift-off techniques. Pad metal is comprised of a conductive material and is preferably comprised of 100 to 300 angstroms of chrome and 1000 to 10,000 angstroms of gold. Pad metal 41 and top contact 20 provide the anchor of the cantilever beam structure to substrate 12.

FIG. 11 illustrates a perspective view of a portion of device 10 taken along line 11-11 of FIG. 10, which has been subjected to further processing. In this step, first sacrificial layer 22 and second sacrificial layer 27 are removed. This process releases the cantilever structure comprised of dielectric layer 34, shorting bar 32 and top electrode 37 so that it is able to move in the direction shown by arrow 45. Preferably, first sacrificial layer 22 and second sacrificial layer 27 are removed by using an oxygen plasma dry etch.

The view shown in FIG. 11 clearly illustrates how shorting bar 32 is fabricated to couple input signal line 16 and output signal line 17 when an electrostatic charge between top electrode 27 and ground 18 pulls the cantilever structure toward ground layer 18. The electrostatic charge is formed when a voltage is applied between top electrode 27 and ground contact 18.

The present invention allows for the formation of a shorting bar 32 wherein the area that makes contact with input signal line 16 and output signal line 17 is smooth, thus enhancing the electrical contact. In addition, the use of first sacrificial layer 22 and second sacrificial layer 27 allows shorting bar 32 to have better step coverage, so that no voids or non-uniform areas are formed. Better step coverage means that device 10 is more manufacturable. Furthermore, device 10 has better electrical characteristics and reliability as a result of the improved step coverage of shorting bar 32. The improved step coverage is a result of using sacrificial layers 22 and 27, where an opening 26 is formed in the first sacrificial layer 22 and then the second sacrificial 27 layer is formed in the opening 26 to provide a recess 28 having smooth, rounded edges.

By now it should be appreciated that structures and methods have been provided for improving the manufacturability of micromechanical devices as well as for providing a micromechanical device having improved electrical characteristics and better reliability. In particular, the aforementioned advantages are obtained by utilizing two sacrificial layers (22 and 27) wherein the second sacrificial layer 27 is not etched to form a recess 28. The recess 28 that is formed thus lacks steep sidewalls and rough areas so that a shorting bar 32 deposited over the recess 28 has improved step coverage and a smooth surface.

Thus, a process for fabricating a micromechanical device, which fully meets the advantages set forth above, has been provided. Although the invention has been described and illustrated with reference to specific illustrative embodiments, it is not intended that the invention be limited to those illustrative embodiments. Those skilled in the art will recognize that variations and modifications can be made without departing from the spirit of the invention. Therefore, all such variations and modifications as fall within the scope of the appended claims and equivalents thereof are intended to be included within the invention.

1. A method of making a device comprising the steps of:
providing a substrate;
forming a first conductive layer over the substrate;
forming a sacrificial layer over the first conductive layer;
forming a dielectric layer over the sacrificial layer, wherein the dielectric layer comprises silicon, oxygen, and nitrogen.
forming a second conductive layer over the sacrificial; and
removing the sacrificial layer.

2. The method of claim 1, wherein the forming the sacrificial layer comprises forming a polyimide layer.

3. The method of claim 1, wherein the forming the dielectric layer further comprises forming a silicon oxynitride.

4. The method of claim 3, wherein forming the silicon oxynitride comprises performing plasma enhanced chemical vapor deposition (PECVD).

5. The method of claim 4, wherein performing PECVD further comprises:
flowing N₂O;
flowing N₂;
flowing NH₃; and
flowing SiH₄.

6. The method of claim 5, wherein performing PECVD occurs at a temperature between approximately 200 and 300 degrees Celsius.

7. The method of claim 6, wherein the temperature is approximately 240 degrees Celsius.

8. The method of claim 1, wherein the dielectric layer further comprises hydrogen.

9. A method of making a microelectronic device comprising the steps of:
providing a substrate;
forming an input signal line over the substrate;
forming an output signal line over the substrate and spaced apart from the input signal line;
forming a sacrificial layer over the input signal line and the output signal line;
forming a dielectric layer over the sacrificial layer, wherein the dielectric layer comprises silicon, oxygen and nitrogen;
removing the sacrificial layer; and
forming a conductive layer over the dielectric layer

10. The method of claim 9, wherein forming the dielectric layer further comprises forming silicon oxynitride.

11. The method of claim 10, wherein forming the silicon oxynitride comprises performing plasma enhanced chemical vapor deposition (PECVD).

12. The method of claim 11, wherein performing PECVD occurs at a temperature between approximately 200 and 300 degrees Celsius.

13. The method of claim 12, wherein the temperature is approximately 240 degrees Celsius.

14. A microelectronic device comprising:
a substrate;
a first conductive layer over the substrate;
a dielectric layer over the first conductive layer, wherein the dielectric layer comprises silicon, oxygen, and nitrogen;
a gap between the first conductive layer and the dielectric layer; and
a second conductive layer over the dielectric layer.

15. The microelectronic device of claim 14, wherein the dielectric layer further comprises silicon oxynitride.

16. The microelectronic device of claim 14, wherein the dielectric layer is part of a cantilever structure.

17. A method of making a device comprising the steps of:
providing a substrate;
forming a first conductive layer over the substrate;
forming a sacrificial layer over the first conductive layer;
forming a dielectric layer over the sacrificial layer, wherein the dielectric layer comprises a silicon oxynitride;
forming a second conductive layer over the sacrificial layer; and
removing the sacrificial layer.

18. The method of claim 17, wherein forming the silicon oxynitride comprises performing plasma enhanced chemical vapor deposition (PECVD).

19. The method of claim 18, wherein performing PECVD occurs at a temperature between approximately 200 and 300 degrees Celsius.

20. The method of claim 19, wherein the temperature is approximately 240 degrees Celsius.
